(19) United States
(12) Patent Application Publication
(10) Pub. No.: US 2024/0142888 A1
(43) Pub. Date: May 2, 2024

(54) TONER AND IMAGE FORMING APPARATUS

(71) Applicant: KYOCERA Document Solutions Inc., Osaka (JP)

(72) Inventor: Takeo MIZOBE, Osaka (JP)

(73) Assignee: KYOCERA Document Solutions Inc., Osaka (JP)

(21) Appl. No.: 18/497,963

(22) Filed: Oct. 30, 2023

(30) Foreign Application Priority Data
Oct. 31, 2022 (JP) 2022-174764

(51) Int. Cl. G03G 9/097; G03G 9/08; G03G 15/08

(52) U.S. Cl. CPC G03G 9/09766; G03G 9/0819; G03G 9/09708; G03G 9/09725; G03G 15/0812

(57) ABSTRACT

A toner includes toner particles each including a toner mother particle and external additive particles attached to the surface of the toner mother particle. The external additive particles include fluororesin particles, specific external additive particles, and silica particles. The specific external additive particles contain barium titanate or strontium titanate. The silica particles have a detachment fraction of at least 5% by mass and no greater than 22% by mass. The detachment fraction of the silica particles is a percentage of a mass M₂ of silica particles of the silica particles that have separated from the toner mother particles after ultrasonication to a mass M₁ of the silica particles included in the toner particles before the ultrasonication. The ultrasonication is application of ultrasonic vibration to a mixed liquid of 5 g of the toner and 105.5 g of a nonionic surfactant-containing aqueous solution containing 0.55 g of a nonionic surfactant.

### INCORPORATION BY REFERENCE

The present application claims priority under 35 U.S.C. § 119 to Japanese Patent Application No. 2022-174764, filed on Oct. 31, 2022. The contents of this application are incorporated herein by reference in their entirety.

### BACKGROUND

The present disclosure relates to a toner and an image forming apparatus.

For example, an electrographic image forming apparatus includes a development device including a developer bearing member (toner bearing member) that carries a developer and a layer thickness restriction member (restriction blade) that restricts the thickness of a developer layer (toner layer). Examples of the developer include a one-component developer including only a toner and a two-component developer including a toner and a carrier.

Examples of the one-component developer include a one-component magnetic developer in which toner particles contain a magnetic powder and a non-magnetic one-component magnetic developer in which toner particles do not contain a magnetic powder. In an image forming apparatus that performs development with a non-magnetic one-component developer, the restriction blade in a development device is in contact with the surface of the toner bearing member. In the following, a development method with a non-magnetic one-component developer using a development device including a restriction blade in contact with the surface of the toner bearing member may be also referred to below as “non-magnetic one-component development”.

In image formation by the non-magnetic one-component development, the toner particles may adhere to the restriction blade due to the restriction blade being in contact with the surface of the toner bearing member. Once the toner adheres to the restriction blade, a uniform toner layer is not formed on the toner bearing member to cause an image defect called a white line. Furthermore, the toner is required to be appropriately charged in image formation by the non-magnetic one-component development. When the toner is excessively charged (overcharged), a toner layer becomes excessively thick and an excessive amount of toner moves to a sheet of a recording medium. The excessive amount of the toner on the sheet of the recording medium moves to the surface of the fixing member to cause an image defect on another sheet of the recording medium (offset). When the amount of charge of the toner is insufficient in image formation by the non-magnetic one-component development, formed images have low image density.

In order to inhibit adhesion of the toner particles to the restriction blade, some toner includes polytetrafluoroethylene particles as external additive particles.

### SUMMARY

According to an aspect of the present disclosure, a toner includes toner particles. The toner particles each include a toner mother particle and external additive particles attached to a surface of the toner mother particle. The external additive particles include fluororesin particles, specific external additive particles, and silica particles. The specific external additive particles contain barium titanate or strontium titanate. The silica particles have a detachment fraction of at least 5% by mass and no greater than 22% by mass. The detachment fraction of the silica particles is a percentage (100×M₂/M₁) of a mass M₂ of silica particles of the silica particles that have separated from the toner mother particles after ultrasonication to a mass M₁ of the silica particles included in the toner particles before the ultrasonication. The ultrasonication is application of ultrasonic vibration with a frequency of 20 kHz and an output of 225 W for 60 seconds to a mixed liquid of 5 g of the toner and 105.5 g of a nonionic surfactant-containing aqueous solution containing 0.55 g of a nonionic surfactant.

According to another aspect of the present disclosure, an image forming apparatus includes a non-magnetic one-component developer, an image bearing member, and a development device that develops an electrostatic latent image formed on a surface of the image bearing member by supplying the non-magnetic one-component developer to the electrostatic latent image. The non-magnetic one-component developer is the aforementioned toner. The development device includes a developer bearing member that carries the non-magnetic one-component developer and a restriction blade that restricts a thickness of a developer layer constituted by the non-magnetic one-component developer. The development device supplies the non-magnetic one-component developer to the electrostatic latent image while forming the developer layer using the restriction blade in contact with the developer bearing member.

### BRIEF DESCRIPTION OF THE DRAWINGS

FIG. 1 is a schematic cross-sectional view of an example of a toner particle included in a toner according to the present disclosure.

FIG. 2 is a diagram illustrating an example of the configuration of an image forming apparatus according to a second embodiment of the present disclosure.

FIG. 3 is a diagram illustrating the configuration of a development device included in the image forming apparatus illustrated in FIG. 2.

### DETAILED DESCRIPTION

Meanings of the terms and the measurement methods used in the present specification are explained first. A toner is a collection (e.g., a powder) of toner particles. An external additive is a collection (e.g., a powder) of external additive particles. Unless otherwise stated, values indicating shape or physical properties for a powder (specific examples include a powder of toner particles and a powder of external additive particles) are number averages of values as measured for a suitable number of particles selected from the powder. The “main component” of a material means a component most abundant in the material in terms of mass unless otherwise stated. In the following description, the term “-based” may be appended to the name of a chemical compound to form a generic name encompassing both the chemical compound itself and derivatives thereof. The term “(meth)acryl” is used as a generic term for both acryl and methacryl. One type of each component described in the present specification may be used independently, or two or more types of the component may be used in combination. “At least one of A and B” means “either or both A and B”.

The volume median diameter (D₅₀) of a powder is a median diameter of the powder as measured using a laser diffraction/scattering type particle size distribution analyzer (“LA-950”, product of HORIBA, Ltd.) unless otherwise stated. Unless otherwise stated, the number average particle diameter of a powder is a number average value of equivalent circle diameters (Heywood diameters: diameters of circles having the same areas as projected areas of the primary particles) of primary particles of the powder as measured using a scanning electron microscope. The number average primary particle diameter is a number average value of equivalent circle diameters of 100 primary particles, for example. The amount of charge (unit: μC/g) is a value as measured using a compact suction-type charge measuring device (e.g., “MODEL 212HS”, product of TREK, INC.) in an environment at a temperature of 25° C. and a relative humidity of 50% unless otherwise stated. The softening point (Tm) is a value as measured using a capillary rheometer (e.g., “CFT-500D”, product of Shimadzu Corporation) unless otherwise stated. On an S-shaped curve (vertical axis: temperature, horizontal axis: stroke) plotted using the capillary rheometer, the softening point (Tm) corresponds to a temperature corresponding to a stroke value of “(base line stroke value+maximum stroke value)/2”. Meanings of the terms and the measurement methods used in the present specification have been explained so far.

### First Embodiment: Toner

A toner according to a first embodiment of the present disclosure includes toner particles. The toner particles each include a toner mother particle and external additive particles attached to the surface of the toner mother particle. The external additive particles include fluororesin particles, specific external additive particles, and silica particles. The specific external additive particles contain barium titanate or strontium titanate. The silica particles have a detachment fraction of at least 5% by mass and no greater than 22% by mass. The detachment fraction of the silica particles is a percentage (100×M₂/M₁) of a mass M₂ of silica particles of the silica particles that have separated from the toner mother particles after ultrasonication to a mass M₁ of the silica particles included in the toner particles before the ultrasonication. The ultrasonication is application of ultrasonic vibration with a frequency of 20 kHz and an output of 225 W for 60 seconds to a mixed liquid of 5 g of the toner and 105.5 g of a nonionic surfactant-containing aqueous solution containing 0.55 g of a nonionic surfactant.

The toner according to the present embodiment is suitable as a positively chargeable non-magnetic one-component developer for electrostatic latent image development, for example.

As a result of having the above features, the toner according to the present embodiment can form images with desired image density while inhibiting occurrence of a white line and offset. The reasons thereof are inferred as follows. The fluororesin particles included in the toner particles have non-adhesion, which is a characteristic of fluororesin. As such, the fluororesin particles attach only very weakly to the surfaces of the toner mother particles. Therefore, the fluororesin particles easily separate from the toner mother particles as a result of the restriction blade applying line pressure to the toner particles upon the toner particles passing through a restriction nip (gap between the developer bearing member and the restriction blade). The separated fluororesin particles coats the surfaces of the restriction blade and the developer bearing member. Large particles such as the toner particles hardly adhere to the restriction blade and the developer bearing member coated with the fluororesin particles. As such, the toner according to the present embodiment including the fluororesin particles can inhibit the toner particles from adhering to the surfaces of the restriction blade and the developer bearing member and can form a uniform toner layer on the developer bearing member. As a result, the toner according to the present embodiment can inhibit occurrence of a white line. Note that the fluororesin particles are small in particle diameter compared to that of the toner particles and the like. Therefore, the restriction blade and the developer bearing member even coated with the fluororesin particles do not affect toner image formation.

The fluororesin particles are negatively chargeable. Therefore, once the restriction blade or the developer bearing member is coated with the fluororesin particles, the toner particles are readily charged excessively (overcharged). Overcharge of the toner particle tends to occur when consecutive printing is performed in a low-temperature and low-humidity environment. When toner particles of a known toner are excessively charged (overcharged), the toner layer becomes excessively thick and an excessive amount of the known toner is transferred to a sheet of a recording medium. Thereafter, an excessive amount of the known toner on the recording medium adheres to the surface of the fixing member, thereby causing offset. In view of the foregoing, the toner particles of the toner according to the present embodiment includes the specific external additive particles. The specific external additive particles contains barium titanate or strontium titanate, each of which is a perovskite compound, and therefore have an angular granular shape derived from the perovskite structure. When the toner particles are about to become charged excessively, the specific external additive particles serve to reduce the charge of the toner particles by releasing the charge from the tip ends of the angular particles to surrounding members (the restriction blade and the developer bearing member). As a result, the toner according to the present embodiment can inhibit overcharge of the toner particles to inhibit occurrence of offset.

Furthermore, toner particles included in a known toner usually include silica particles. Some of the silica particles separate (become free) from the toner mother particles in development to adhere to the restriction blade and the developer bearing member. Once a large amount of the silica particles adhere to the restriction blade or the developer bearing member, the silica particles function as an abrasive to polish (remove) the fluororesin particles coating the restriction blade or the developer bearing member. Thus, once a large amount of the silica particles separate from the toner mother particles in development, the function of the fluororesin particles (inhibition of occurrence of a white line) is inhibited. In view of the foregoing, in the toner according to the present embodiment, the silica particles have a detachment fraction of no greater than 22% by mass, which is relatively low. Therefore, in the toner of the present disclosure, the amount of the silica particles separated from the toner mother particles in development is reduced to allow the fluororesin particles to fully exhibit their function. As a result, the toner according to the present embodiment can satisfactory inhibit occurrence of a white line. The detachment fraction of the silica particles can be reduced by strongly attaching the silica particles to the toner mother particles. However, when strong attachment of the silica particles to the toner mother particles decreases fluidity of the toner particles. Therefore, the detachment fraction of the silica particles is set to at least 5% by mass in order to ensure fluidity of the toner particles in the toner of the present embodiment. Thus, the toner according to the present embodiment can form images with desired image density with fluidity of the toner particles ensured. The toner according to the present embodiment is described further in detail below.

### [Toner Particles]

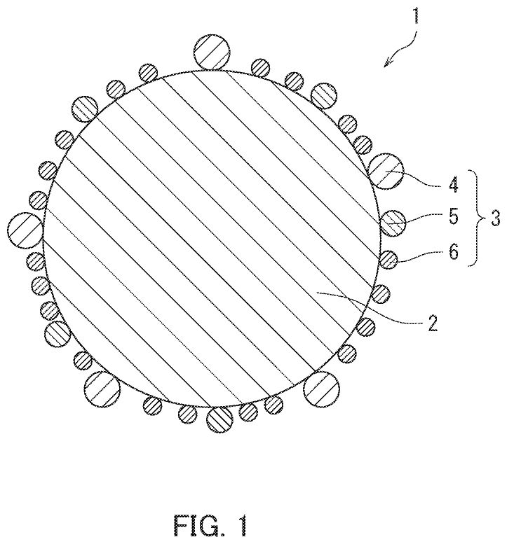

One example of the toner particles is described below with reference to FIG. 1. FIG. 1 illustrates a toner particle 1 which is an example of the toner particles included in the toner according to the present embodiment. The toner particle 1 illustrated in FIG. 1 includes a toner mother particle 2 and external additive particles 3 attached to the surface of the toner mother particle 2. The external additive particles 3 include fluororesin particles 4, specific external additive particles 5, and silica particles 6. The fluororesin particles 4 are larger in diameter than the specific external additive particles 5 and the silica particles 6. The specific external additive particles 5 are larger in diameter than the silica particles 6.

The toner particles have been described so far with reference to FIG. 1. However, the toner particles of the toner according to the present embodiment may have a structure different from that of the toner particle 1 described with reference to FIG. 1. For example, the toner particles may be toner particles (also referred to below as capsule toner particles) each with a shell layer. In the capsule toner particles, the toner mother particles each include a toner core containing for example a binder resin and a shell layer covering at least a part of the surface of the toner core. The sizes of the fluororesin particles, the specific external additive particles, and the silica particles may be in any order. Details of the toner particles included in the toner according to the present embodiment have been described so far with reference to FIG. 1.

### [External Additive Particles]

The external additive particles are attached to the surfaces of the toner mother particles. The external additive particles include fluororesin particles, specific external additive particles, and silica particles.

### (Fluororesin Particles)

The fluororesin particles contain fluororesin. The fluororesin have a percentage content in the fluororesin particles of for example at least 90% by mass, and preferably 100% by mass. As described previously, the fluororesin particles separate from the toner mother particles when the toner particles pass through the restriction nip to adhere to and coat the restriction blade and the developer bearing member.

Examples of the fluororesin contained in the fluororesin particles include polytetrafluoroethylene (PTFE), polychlorotrifluoroethylene, polyvinylidene fluoride, polydichlorodifluoroethylene, tetrafluoroethylene-perfluoroalkylvinyl ether copolymers (PFA), tetrafluoroethylene-hexafluoropropylene copolymers (FEP), tetrafluoroethylene-ethylene copolymers, tetrafluoroethylene-hexafluoropropylene-perfluoroalkylvinyl ether copolymers, and tetrafluoroethylene-perfluoroalkoxyethylene copolymers. The fluororesin is preferably PTFE, PFA, or FEP.

The fluororesin particles have a number average primary particle diameter of preferably at least 70 nm and no greater than 400 nm, more preferably at least 150 nm and no greater than 350 nm, and further preferably at least 150 nm and no greater than 250 nm. As a result of the number average primary particle diameter of the fluororesin particles being set to at least 70 nm, separation of the fluororesin particles from the toner mother particles can be promoted when the toner particles pass through the restriction nip. As a result of the number average primary particle diameter of the fluororesin particles being set to no greater than 400 nm, separation of the fluororesin particles from the toner mother particles can be inhibited when the toner particles pass through the restriction nip.

The fluororesin particles have a content in the toner particles of preferably at least 0.1 parts by mass and no greater than 2.0 parts by mass relative to 100 parts by mass of the toner mother particles, and more preferably at least 0.4 parts by mass and no greater than 1.0 parts by mass. As a result of the content of the fluororesin particles being set to at least 0.1 nm, separation of the fluororesin particles from the toner mother particles can be promoted when the toner particles pass through the restriction nip. As a result of the content of the fluororesin particles being set to no greater than 2.0 nm, separation of the fluororesin particles from the toner mother particles can be inhibited when the toner particles pass through the restriction nip.

### (Specific External Additive Particles)

The specific external additive particles contain barium titanate or strontium titanate. The barium titanate or the strontium titanate has a percentage content in the specific external additive particles of for example at least 90% by mass, and preferably 100% by mass. As described previously, the specific external additive particles release charge from the toner particles to reduce charge of the toner particles when the toner particles are excessively charged.

The specific external additive particles have a number average primary particle diameter of preferably at least 15 nm and no greater than 100 nm, and more preferably at least 30 nm and no greater than 70 nm. As a result of the number average primary particle diameter of the specific external additive particles being set to at least 15 nm, charge can be easily released from the toner particles when the toner particles are excessively charged. As a result of the number average primary particle diameter of the specific external additive particles being set to no greater than 100 nm by contrast, separation of the specific external additive particles from the toner mother particles can be inhibited.

The specific external additive particles have a content in the toner particles of preferably at least 0.3 parts by mass and no greater than 5.0 parts by mass relative to 100 parts by mass of the toner mother particles, more preferably at least 0.7 parts by mass and no greater than 3.0 parts by mass, and further preferably at least 0.7 parts by mass and no greater than 1.5 parts by mass. As a result of the content of the specific external additive particles being set to at least 0.3 parts by mass and no greater than 5.0 parts by mass, the toner according to the present embodiment can further effectively inhibit occurrence of offset.

Preferably, the surfaces of the specific external additive particles are subjected to hydrophobizing treatment. A preferable surface treatment agent used for the hydrophobizing treatment is a silane coupling agent. The silane coupling agent is preferably an alkylalkoxysilane (particularly, monoalkyltrialkoxysilane). Preferably, the alkyl group of the alkylalkoxysilane is an alkyl group having a carbon number of at least 3 and no greater than 8.

Examples of the alkylalkoxysilane include propyltrimethoxysilanes (specific examples include n-propyltrimethoxysilane and isopropyltrimethoxysilane), propyltriethoxysilanes (specific examples include n-propyltriethoxysilane and isopropyltriethoxysilane), butyltrimethoxysilanes (specific examples include n-butyltrimethoxysilane and isobutyltrimethoxysilane), butyltriethoxysilanes (specific examples include n-butyltriethoxysilane and isobutyltriethoxysilane), hexyltrimethoxysilanes (specific examples include n-hexyltrimethoxysilane), hexyltriethoxysilanes (specific examples include n-hexyltriethoxysilane), octyltrimethoxysilanes (specific examples include n-octyltrimethoxysilane), and octyltriethoxysilanes (specific examples include n-octyltriethoxysilane). The alkylalkoxysilane is preferably isobutyltrimethoxysilane.

No particular limitations are placed on a method for preparing specific external additive particles. An example of the method is a method (baking) of baking a mixture of titanium compounds (e.g., titanium oxide or metatitanic acid) and a strontium compound or a barium compound (e.g., strontium carbonate or barium carbonate).

Alternatively, the method for preparing the specific external additive particles may be the normal pressure heating reaction. According to the normal pressure heating reaction method, compared to the baking, there is a tendency to obtain specific external additive particles with a smaller number average primary particle diameter. Examples of the normal pressure heating reaction include: a method A of causing a reaction between a barium compound and a hydrolysate of a titanium compound in a strong alkaline aqueous solution; a method B of causing a wet reaction between a barium compound and a hydrolysate of a titanium compound in presence of hydrogen peroxide; a method C of heating while mixing a barium compound in a solution state and a titanium compound in a solution state or a slurry state; and a method D of adding an alkaline aqueous solution to a mixture while heating the mixture to a temperature of at least 50° C., the mixture being obtained by mixing a barium source and a mineral acid peptized product of a hydrolysate of a titanium compound.

Examples of methods for surface treatment of the specific external additive particles include: a first method of heating after dripping or spraying of a surface treatment agent onto or toward a solution containing the specific external additive particles (also referred to below as a base) before surface treatment under stirring; and a second method of heating after addition of the base to a solution of a surface treatment agent under stirring. The heating conditions in the first method and the second method may be a heating temperature of at least 80° C. and no greater than 140° C. and a heating time of at least 0.5 hours and no greater than 6 hours.

In the surface treatment, the amount of the surface treatment agent used (active component conversion) is preferably at least 3 parts by mass and no greater than 30 parts by mass relative to 100 parts by mass of the base, and more preferably at least 10 parts by mass and no greater than 20 parts by mass.

### (Silica Particles)

The silica particles impart fluidity to the toner particles. The silica particles are preferably silica particles subjected to surface treatment for rendering the silica particles positively chargeable. The silica particles have a number average primary particle diameter of preferably at least 10 nm and no greater than 300 nm, more preferably at least 10 nm and no greater than 100 nm, and further preferably at least 10 nm and no greater than 40 nm. As a result of the number average primary particle diameter of the silica particles being set to at least 10 nm, the silica particles can be inhibited from being buried in the toner mother particles. As a result of the number average primary particle diameter of the silica particles being set to no greater than 300 nm by contrast, the silica particles can be inhibited from separating from the toner mother particles.

The detachment fraction of the silica particles is at least 5% by mass and no greater than 22% by mass, and preferably at least 7% by mass and no greater than 15% by mass. As a result of the detachment fraction of the silica particles being set to at least 5% by mass, sufficient fluidity can be imparted to the toner particles. As a result, the toner according to the present embodiment can form images with desired image density. As a result of the detachment fraction of the silica particles being set to no greater than 22% by mass, the amount of silica particles separated from the toner mother particles in development can be reduced to allow the fluororesin particles to fully exhibit their function. Thus, the toner according to the present embodiment can inhibit occurrence of offset.

The detachment fraction of the silica particles can be adjusted mainly by adjusting the content of the silica particles in the toner particles and conditions (e.g., a stirring speed and an external additive addition time) in external additive addition of the silica particles to the toner mother particles. Specifically, the larger the content of the silica particles is, the higher the detachment fraction of the silica particles is. As the stirring speed is increased, the silica particles become strongly attached to the toner mother particles, thereby reducing the detachment fraction of the silica particles. Also, as the external additive addition time is decreased, the silica particles become strongly attached to the toner mother particles, thereby reducing the detachment fraction of the silica particles.

The detachment fraction of the silica particles is a percentage (100×M₂/M₁) of the mass M₂ of silica particles that have separated from the toner mother particles after ultrasonication to the mass M₁ of the silica particles included in the toner particles before the ultrasonication. The ultrasonication herein is application of ultrasonic vibration with a frequency of 20 kHz and an output of 225 W for 60 seconds to a mixed liquid of 5 g of the toner and 105.5 g of a nonionic surfactant-containing aqueous solution containing 0.55 g of a nonionic surfactant (e.g., Triton (registered Japanese trademark)-X100 produced by The Dow Chemical Company). The mass M₁ and the mass M₂ can be measured by fluorescent X-ray analysis, for example. Any other detailed measurement conditions may be those set in the method described in Example and methods in compliance therewith.

In terms of allowing the silica particles to sufficiently exhibit their function while inhibiting separation of the silica particles from the toner mother particles, the content of the silica particles in the toner particles is preferably at least 0.1 parts by mass and no greater than 15.0 parts by mass relative to 100 parts by mass of the toner mother particles, and more preferably at least 0.5 parts by mass and no greater than 3.0 parts by mass.

### (Additional External Additive Particles)

The external additive may further include additional external additive particles besides the fluororesin particles, the specific external additive particles, and the silica particles. Examples of the additional external additive particles include particles of metal oxides (e.g., alumina, magnesium oxide, and zinc oxide), particles of organic acid compounds such as fatty acid metal salts (specific examples include zinc stearate), and resin particles other than the fluororesin particles.

### [Toner Mother Particles]

The toner mother particles contain a binder resin as a main component, for example. The toner mother particles may further contain an internal additive (e.g., at least one of a colorant, a releasing agent, a charge control agent, and a magnetic powder) as necessary. The toner mother particles may be produced by an pulverization method and an aggregation method, and the pulverization method is preferable.

### (Binder Resin)

In terms of providing a toner excellent in low-temperature fixability, the toner mother particles preferably contain a thermoplastic resin as the binder resin, and more preferably contain a thermoplastic resin at a percentage content of at least 85% by mass in the total of the binder resin. Examples of the thermoplastic resin include styrene resins, acrylic acid ester resins, olefin resins (e.g., polyethylene resin and polypropylene resin), vinyl resins (e.g., vinyl chloride resin, polyvinyl alcohol, vinyl ether resin, and N-vinyl resin), polyester resins, polyamide resins, and urethane resins. Alternatively, a copolymer of any of these resins, that is, a copolymer (e.g., styrene-acrylic acid ester resin or styrene-butadiene resin) in which any repeating unit has been introduced into any of the resins can be used as the binder resin.

The binder resin has a percentage content in the toner mother particles of preferably at least 60% by mass and no greater than 95% by mass, and more preferably at least 75% by mass and no greater than 90% by mass.

In terms of increasing low-temperature fixability of the toner according to the present embodiment, the binder resin is preferably polyester resin. The polyester resin can be obtained by condensation polymerization of one or more polyhydric alcohols and one or more polybasic carboxylic acids. Examples of a polyhydric alcohol that can be used for synthesis of the polyester resin include dihydric alcohols (e.g., diol compounds and bisphenol compounds) and trihydric or higher-hydric alcohols. Examples of a polybasic carboxylic acid that can be used for synthesis of the polyester resin include dibasic carboxylic acids and tribasic or higher-basic carboxylic acids. Note that a polybasic carboxylic acid derivative (e.g., an anhydride of a polybasic carboxylic acid or a halide of a polybasic carboxylic acid) that can form an ester bond through condensation polymerization may be used in place of the polybasic carboxylic acid.

Examples of the diol compounds include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenol compounds include bisphenol A, hydrogenated bisphenol A, bisphenol A-ethylene oxide adducts (e.g., polyoxyethylene(2,2)-2,2-bis(4-hydroxyphenyl)propene), and bisphenol A-propylene oxide adducts.

Examples of the trihydric or higher-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the dibasic carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkyl succinic acids (specific examples include n-butylsuccinic acid, isobutylsuccinic acid, n-octylsuccinic acid, n-dodecylsuccinic acid, and isododecylsuccinic acid), and alkenyl succinic acids (specific examples include n-butenylsuccinic acid, isobutenylsuccinic acid, n-octenylsuccinic acid, n-dodecenylsuccinic acid, and isododecenylsuccinic acid).

Examples of the tribasic or higher-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarbolxyl propane, 1,2,4-cyclohexanetricarboxylic acid, tetra(methylenecarboxyl)methane, 1,2,7,8-octanetetracarboxylic acid, pyromellitic acid, and Empol trimer acid.

The polyester resin is preferably a condensation polymer of terephthalic acid, isophthalic acid, bisphenol A-ethylene oxide adduct, and trimellitic acid.

### (Colorant)

The toner mother particles may contain a colorant. The colorant may be a known pigment or dye according to the color of the toner of the present embodiment. In terms of forming high-quality images with the toner according to the present embodiment, the colorant has a content of at least 1 part by mass and no greater than 20 parts by mass relative to 100 parts by mass of the binder resin.

The toner mother particles may contain a black colorant. An example of the black colorant is carbon black. Alternatively, the black colorant may be a colorant adjusted to a black color using a yellow colorant, a magenta colorant, and a cyan colorant.

The toner mother particles may contain a non-black colorant. Examples of the non-black colorant include a yellow colorant, a magenta colorant, and a cyan colorant.

### (Releasing Agent)

The toner mother particles may contain a releasing agent. The releasing agent is used for the purpose of further effectively inhibiting occurrence of offset of the toner according to the present embodiment, for example. The releasing agent preferably has a content of at least 1 part by mass and no greater than 20 parts by mass relative to 100 parts by mass of the binder resin.

Examples of the releasing agent include aliphatic hydrocarbon-based waxes, oxides of aliphatic hydrocarbon-based waxes, plant waxes, animal waxes, mineral waxes, ester waxes having a fatty acid ester as a main component, and waxes in which a fatty acid ester has been partially or fully deoxidized. Examples of the aliphatic hydrocarbon-based waxes include low molecular weight polyethylene, low molecular weight polypropylene, polyolefin copolymers, polyolefin wax, microcrystalline wax, paraffin wax, and Fischer-Tropsch wax. Examples of the oxides of aliphatic hydrocarbon-based waxes include oxidized polyethylene wax and block copolymers of oxidized polyethylene wax. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the ester waxes having a fatty acid ester as a main component include montanic acid ester wax and castor wax. Examples of the waxes in which a fatty acid ester has been partially or fully deoxidized include deoxidized carnauba wax. The releasing agent is preferably carnauba wax.

When the toner mother particles contain a releasing agent, a compatibilizer may be added to the toner mother particles in order to improve compatibility between the binder resin and the releasing agent.

### (Charge Control Agent)

The toner mother particles may contain a charge control agent. The charge control agent is used for the purpose of providing a toner excellent in charge stability or a charge rise characteristic, for example. The charge rise characteristic of the toner is an indicator as to whether the toner can be charged to a specific charge level in a short period of time. When the toner mother particles contain a positively chargeable charge control agent, cationicity of the toner mother particles can be increased.

Examples of the positively chargeable charge control agent include azine compounds, direct dyes, acid dyes, alkoxylated amine, alkylamide, quaternary ammonium salt compounds, and resins having a quaternary ammonium cationic group. The charge control agent is preferably a quaternary ammonium salt compound.

Examples of the quaternary ammonium salt compound include benzyldecylhexylmethyl ammonium chloride, decyltrimethyl ammonium chloride, 2-(methacryloyloxy)ethyl trimethylammonium chloride, and dim ethyl aminopropyl acrylamide methyl chloride quaternary salt.

In terms of providing a toner excellent in charge stability, the charge control agent has a content of at least 1 part by mass and no greater than 10 parts by mass relative to 100 parts by mass of the binder resin.

### [Preferable Composition]

Preferably, the toner according to the present embodiment has any of compositions 1 to 5 shown below in Table 1. Note that “Part” below in Table 1 indicates a numerical range in terms of part by mass of corresponding particles in the toner particles to 100 parts by mass of the toner mother particles. For example, “0.4-0.6”, which corresponds to the content of the fluororesin particles in Composition 1, indicates that the toner particles have a content of the fluororesin particles of at least 0.4 parts by mass and no greater than 0.6 parts by mass relative to 100 parts by mass of the toner mother particles. “PTFE” being a type of the fluororesin particles indicates polytetrafluoroethylene particles. “PFA” indicates tetrafluoroethylene-perfluoroalkylvinylether copolymer particles. “FEP” indicates tetrafluoroethylene-hexafluoropropylene copolymer particles. “Sr-1”, “Sr-2”, and “Ba-2” each being a type of the specific external additive particles respectively indicate strontium titanate particles (Sr-1), strontium titanate particles (Sr-2), and barium titanate particles (Ba-1) that were used in Examples.

TABLE 1

| | | | Specific | | | |
|---|---|---|---|---|---|---|
| | | | external | | Silica particles | |
| | Fluororesin | | additive | | | Detachment |
| Compo- | particles | | particles | | | fraction |
| sition | Type | Part | Type | Part | Part | [wt %] |
| 1 | PTFE | 0.4-0.6 | Sr-1 | 0.9-1.1 | 1.8-2.2 | 9-11 |
| 2 | PTFE | 0.6-0.8 | Ba-1 | 0.4-0.6 | 2.3-2.7 | 18-22 |
| 3 | PTFE | 0.2-0.4 | Sr-2 | 1.8-2.2 | 1.4-1.6 | 5-6 |
| 4 | PFA | 0.4-0.6 | Ba-1 | 0.4-0.6 | 1.8-2.2 | 9-11 |
| 5 | FEP | 0.4-0.6 | Sr-2 | 1.8-2.2 | 1.8-2.2 | 9-11 |

### [Toner Production Method]

The toner of the present disclosure can be produced by a production method including toner mother particle preparation and external additive addition, for example.

### (Toner Mother Particle Preparation)

In the toner mother particles preparation, the toner mother particles are prepared by an aggregation method or a pulverization method, for example.

The aggregation method includes an aggregation step and a coalescence step, for example. In the aggregation step, fine particles containing components constituting the toner mother particles are aggregated in a aqueous medium to form aggregated particles. In the coalescence step, components included in the aggregated particles are coalesced in the aqueous medium to form toner mother particles.

The pulverization method is described next. According to the pulverization method, the toner mother particles can be relatively easily prepared and the manufacturing cost can be reduced. The toner mother particle preparation by the pulverization method includes a melt-kneading step and a pulverization step. The toner mother particle preparation may further include a mixing step before the melt-kneading step. Alternatively or additionally, the toner mother particle preparation may further include at least one of a fine pulverization step and a classification step after the pulverization step.

In the mixing step, the binder resin and an internal additive added as necessary are mixed to obtain a mixture. In the melt-kneading step, a toner material is melt-kneaded to obtain a melt-kneaded product. The toner materials may be the mixture obtained in the mixing, for example. In the pulverization step, the resultant melt-kneaded product is cooled to for example room temperature (25° C.) and then pulverized to obtain a pulverized product. If the pulverized product obtained in the pulverization step should have a small diameter, a step (fine pulverization step) of further pulverizing the pulverized product may be performed. Furthermore, the resultant pulverized product may be classified (a classification step) in order to adjust the particle size of the pulverized product. Through the above steps, toner mother particles being a pulverized product are obtained.

### (External Additive Addition)

In the external additive addition, toner particles are obtained by attaching the external additive particles including the fluororesin particles, the specific external additive particles, and the silica particles to the surfaces of the toner mother particles. No particular limitations are placed on the method for attaching the external additive particles to the surfaces of the toner mother particles, and an example of the method is stirring the toner mother particles and the external additive particles using a mixer or the like. An example of the mixer is an FM mixer (product of Nippon Coke & Engineering Co., Ltd.).

The stirring speed in the mixing step in the external additive addition is preferably at least 2000 rpm and no greater than 5000 rpm, and more preferably at least 3000 rpm and no greater than 4000 rpm. The external additive addition time is preferably at least 7 minutes and no greater than 38 minutes, and more preferably at least 20 minutes and no greater than 30 minutes.

### Second Embodiment: Image Forming Apparatus

An image forming apparatus according to a second embodiment of the present disclosure includes a non-magnetic one-component developer, an image bearing member, and a development device that develops an electrostatic latent image formed on the surface of the image bearing member by supplying the non-magnetic one-component developer to the electrostatic latent image. The non-magnetic one-component developer is the toner of the first embodiment. The development device includes a developer bearing member that carries the non-magnetic one-component developer and a restriction blade that restricts the thickness of a developer layer constituted by the non-magnetic one-component developer. The development device supplies the non-magnetic one-component developer to the electrostatic latent image while forming the developer layer using the restriction blade in contact with the developer bearing member.

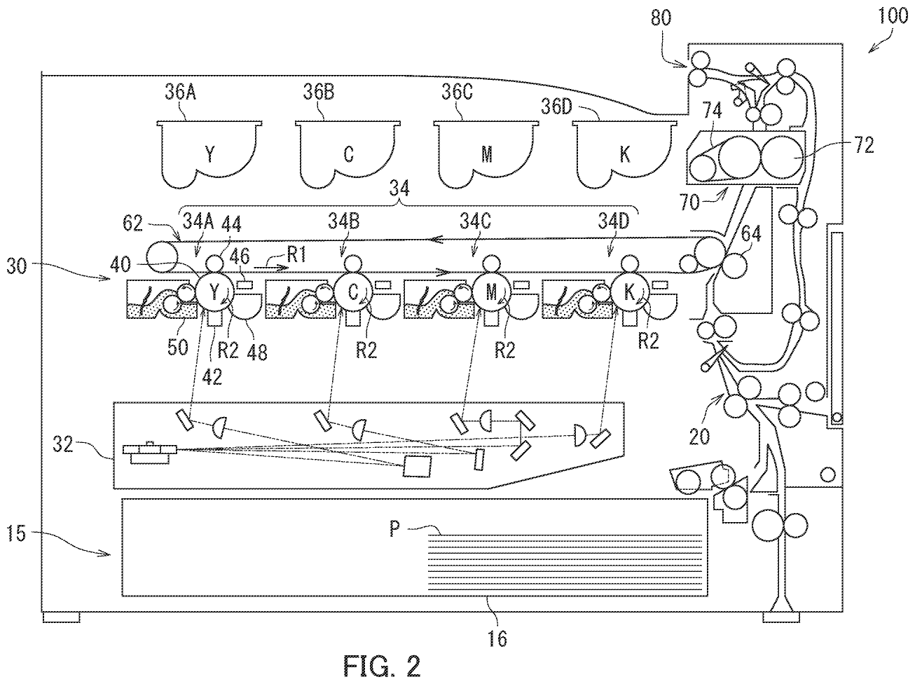

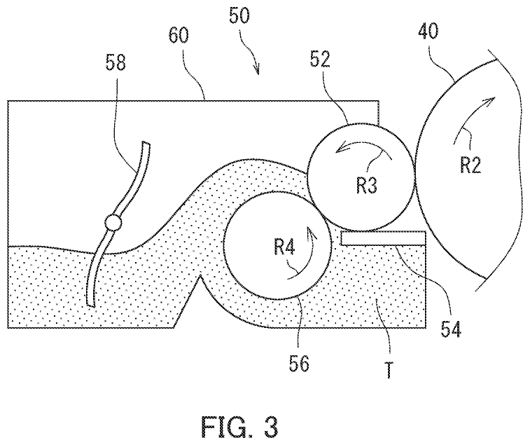

The image forming apparatus according to the present embodiment is described with reference to the accompanying drawings. FIG. 2 is a diagram illustrating an example of the configuration of the image forming apparatus according to the present embodiment. FIG. 3 for reference is a diagram illustrating the configuration of the development device included in the image forming apparatus in FIG. 2. Note that the drawings schematically illustrate elements of configuration in order to facilitate understanding. Properties such as the size, number, and shape of each element of configuration illustrated in the drawings may differ from actual properties in order to facilitate preparation of the drawings.

As shown in Table 2, an image forming apparatus 100 is a printer employing the non-magnetic one-component development for forming images on sheets P of a recording medium. The image forming apparatus 100 includes a feeding section 15, a conveyance section 20, an image forming section 30, and an ejection section 80.

The feeding section 15 includes a cassette 16 that accommodates a plurality of sheets P. The sheets P are paper sheets or synthetic resin sheets, for example. The feeding section 15 feeds the sheets P to the conveyance section 20 one at a time. The conveyance section 20 conveys the sheet P to the image forming section 30. The image forming section 30 forms an image on the sheet P. The conveyance section 20 conveys the sheet P with the image formed thereon to the ejection section 80. The ejection section 80 ejects the sheet P out of the image forming apparatus 100.

The image forming section 30 includes a light exposure unit 32, a first toner image generating unit 34A, a second toner image generating unit 34B, a third toner image generating unit 34C, a fourth toner image generating unit 34D, a first toner container 36A, a second toner container 36B, a third toner container 36C, a fourth toner container 36D, an intermediate transfer belt 62, a secondary transfer roller 64, and a fixing device 70. Here, the image forming apparatus 100 is a tandem image forming apparatus and the first toner image generating unit 34A, the second toner image generating unit 34B, the third toner image generating unit 34C, and the fourth toner image generating unit 34D are arranged in a straight line along the intermediate transfer belt 62.

Note that in order to avoid redundancy in the following description of the present specification, the first toner image generating unit 34A, the second toner image generating unit 34B, the third toner image generating unit 34C, and the fourth toner image generating unit 34D may be also referred to below respectively as a toner image generating unit 34A, a toner image generating unit 34B, a toner image generating unit 34C, and a toner image generating unit 34D. Likewise, the first toner container 36A, the second toner container 36B, the third toner container 36C, and the fourth toner container 36D may be also referred to below respectively as a toner container 36A, a toner container 36B a toner container 36C, and a toner container 36D.

The light exposure unit 32 irradiates the toner image generating unit 34A to the toner image generating unit 34D with light based on image data to form electrostatic latent images on the toner image generating unit 34A to the toner image generating unit 34D.

The toner image generating unit 34A forms a yellow toner image based on a corresponding one of the electrostatic latent images. The toner image generating unit 34B forms a cyan toner image based on a corresponding one of the electrostatic latent images. The toner image generating unit 34C forms a magenta toner image based on a corresponding one of the electrostatic latent images. The toner image generating unit 34D forms a black toner image based on a corresponding one of the electrostatic latent images.

The toner container 36A accommodates a toner for forming yellow toner images. The toner container 36B accommodates a toner for forming cyan toner images. The toner container 36C accommodates a toner for forming magenta toner images. The toner container 36D accommodates a toner for forming black toner images. The toners accommodated in the toner container 36A to the toner container 36D each are the toner (toner T indicated in FIG. 3) according to the first embodiment.

The intermediate transfer belt 62 circulates in a direction indicated by an arrow R1 in FIG. 2. The toner images of four colors are sequentially transferred to the outer surface of the intermediate transfer belt 62 from the toner image generating unit 34A to the toner image generating unit 34D. The secondary transfer roller 64 transfers the toner images formed on the outer surface of the intermediate transfer belt 62 to the sheet P. The fixing device 70 applies heat and pressure to the sheet P to fix the toner images to the sheet P.

The overview of the configuration of the image forming apparatus 100 has been described so far. The details of configuration of the image forming apparatus 100 are described next. Note that each of the toner image generating unit 34A, the toner image generating unit 34B, the toner image generating unit 34C, and the toner image generating unit 34D is also referred to below as a toner image generating unit 34 where there is no need to distinguish them.

Each of the toner image generating units 34 includes a photosensitive drum 40 as an image bearing member, a charger 42, a development device 50, a primary transfer roller 44, a static eliminator 46, and a cleaner 48. The charger 42, the development device 50, the primary transfer roller 44, the static eliminator 46, and the cleaner 48 are arranged in the stated order along the circumferential surface of the photosensitive drum 40 in the toner image generating unit 34.

The photosensitive drum 40 is disposed in contact with the outer surface of the intermediate transfer belt 62. The primary transfer roller 44 is disposed opposite to the photosensitive drum 40 with the intermediate transfer belt 62 therebetween.

The photosensitive drum 40 rotates in a direction indicated by an arrow R2 in FIG. 2. The charger 42 charges the circumferential surface of the photosensitive drum 40. The circumferential surface of the photosensitive drum 40 is irradiated with light by the light exposure unit 32, thereby forming an electrostatic latent image.

As the photosensitive drum 40, a photosensitive member including a photosensitive layer containing amorphous silicon or a photosensitive member including a photosensitive layer containing an organic photoconductor can be used.

As illustrated in FIG. 3, the development device 50 includes a development roller 52 as a toner bearing member, a restriction blade 54, a supply roller 56, a stirring member 58, and a casing 60. The development device 50 supplies the toner T to the electrostatic latent image formed on the circumferential surface of the photosensitive drum 40 to attach the toner T to the electrostatic latent image, thereby developing the electrostatic latent image. Thus, a toner image is formed on the circumferential surface of the photosensitive drum 40.

The development roller 52 carries the toner T. The toner T is the toner (non-magnetic one-component developer) according to the first embodiment. The toner T is supplied from a corresponding one of the toner containers (any of the toner container 36A to the toner container 36D illustrated in FIG. 2). The development roller 52 is disposed in contact with the photosensitive drum 40 for driven rotation in a direction indicated by an arrow R3 in FIG. 3 as the photosensitive drum 40 rotates. The development roller 52 supplies the carried toner T to the photosensitive drum 40.

The restriction blade 54 restricts the thickness of a toner layer (not illustrated) constituted by the toner T. The toner layer is formed on the development roller 52. The restriction blade 54 has one end that is in contact with the circumferential surface of the development roller 52. The restriction blade 54 is a leaf spring, for example, and is pressed against the development roller 52 by a given pressure. Examples of the constituent material of the restriction blade 54 include resins (specific examples include silicone resin and urethane resin), metals (specific examples include stainless steel, aluminum, copper, brass, and phosphor bronze), and composite materials of these.

The supply roller 56 supplies the toner T to the development roller 52. The supply roller 56 is in contact with the development roller 52 and supported in a rotatable manner in a direction indicated by an arrow R4 in FIG. 3.

The stirring member 58 transports the toner T toward the supply roller 56 while stirring the toner T. The casing 60 accommodates the toner T and each member of the development device 50.

The development device 50 is configured to develop the electrostatic latent image into a toner image by supplying the toner T (in detail, toner T included in the toner layer) to the electrostatic latent image formed on the circumferential surface of the photosensitive drum 40 while forming the toner layer using the restriction blade 54 in contact with the development roller 52.

Description of the details of the configuration of the image forming apparatus 100 is continued with reference to FIG. 2. The primary transfer rollers 44 transfer the toner images formed on the circumferential surfaces of the respective photosensitive drums 40 to the outer surface of the intermediate transfer belt 62. The static eliminators 46 eliminate static electricity from the circumferential surfaces of the respective photosensitive drums 40 after the toner images have been transferred to the intermediate transfer belt 62. The cleaners 48 remove the toner T remaining on the circumferential surfaces of the respective photosensitive drums 40. The cleaners 48 each includes a cleaning blade, for example.

The toner images transferred to the outer circumferential surface of the intermediate transfer belt 62 are transferred to the sheet P by the secondary transfer roller 64. That is, the secondary transfer roller 64 corresponds to a transfer section that transfers the toner images formed on the circumferential surfaces of the respective photosensitive drums 40 to the sheet P by way of the intermediate transfer belt 62. The sheet P with the toner images transferred thereto is conveyed to the fixing device 70 by the conveyance section 20. The fixing device 70 includes a pressure roller 72 that applies pressure to the toner images transferred to the sheet P and a fixing belt that applies heat to the toner images transferred to the sheet P. Note that a fixing roller may be used in place of the fixing belt 74. The sheet P conveyed to the fixing device 70 receives heat and pressure between the pressure roller 72 and the fixing belt 74. Thus, the toner images (an image of the superimposed toner images) are fixed to the sheet P. Thereafter, the sheet P is ejected out of the image forming apparatus 100 through the ejection section 80. In the manner described above, the image forming apparatus 100 forms the image on the sheet P.

The image forming apparatus 100 uses the toner according to the first embodiment as a non-magnetic one-component developer and therefore can form images with desired image density while inhibiting occurrence of a white line and offset.

The image forming apparatus 100, which is an example of the image forming apparatus of the present disclosure, has been described so far. However, the image forming apparatus of the present disclosure is not limited to the above-described image forming apparatus 100. For example, the image forming apparatus of the present disclosure may be a monochrome image forming apparatus. The monochrome image forming apparatus includes a single toner image generating unit and a single toner container, for example. Alternatively, the image forming apparatus of the present disclosure may be an image forming apparatus employing the direct transfer process. In the image forming apparatus employing the direct transfer process, the transfer section directly transfers a toner image on an image bearing member to a sheet of a recording medium.

### EXAMPLES

The following describes the present disclosure further in detail using examples. However, the present disclosure is not limited to the scope of the examples.

### [Measurement of Number Average Primary Particle Diameter]

The number average primary particle diameter of each type of particles (e.g., fluororesin particles, silica particles, and specific external additive particles) used in the present examples was measured at a magnitude of 30,000× using a scanning electron microscope (“JSM-7600F”, product of JEOL Ltd., field emission type scanning electron microscope). In the number average primary particle diameter measurement, equivalent circle diameters (Heywood diameters: diameters of circles having the same areas as projected areas of the primary particles) of 100 primary particles of each type of the particles were measured and a number average thereof was obtained.

### [Preparation of Binder Resin]

A reaction vessel was charged with 1.0 mol of a bisphenol A-ethylene oxide adduct (polyoxyethylene(2,2)-2,2-bis(4-hydroxyphenyl)propene), 4.5 mol of terephthalic acid, 0.5 mol of trimellitic anhydride, and 4 g of dibutyl tin oxide. After a nitrogen atmosphere was created inside the reaction vessel, a polycondensation reaction was allowed to occur by maintaining the contents of the reaction vessel at 230° C. for 8 hours. Next, the pressure inside the reaction vessel was reduced until the internal pressure of the reaction vessel reached 8.3 kPa. This distilled any unreacted raw materials remaining in the reaction vessel. Next, the contents of the reaction vessel were washed and dried. Thus, a binder resin (softening point 120° C.) being a polyester resin was obtained.

### [Preparation of Toner Mother Particles]

Using an FM mixer (“FM-20B”, product of Nippon Coke & Engineering Co., Ltd.), 100 parts by mass of the resultant binder resin (polyester resin), 5 parts by mass of a carbon black (“REGAL (registered Japanese trademark) 330R”, product of Cabot Corporation) as a colorant, 10 parts by mass of a carnauba wax (“Carnauba No. 1”, product of S. Kato & Co.) as a releasing agent, and 3 parts by mass of a quaternary ammonium salt compound (“FCA210PS”, product of Fujikura Kasei Co., Ltd.) as a charge control agent were mixed. Thereafter, the resultant mixture was melt-kneaded at 150° C. using a twin screw extruder (“TEM45”, product of SHIBAURA MACHINE CO., LTD.). Thereafter, the resultant melt-kneaded product was cooled. The cooled melt-kneaded product was coarsely pulverized using a FEATHER MILL (registered Japanese trademark) (“MODEL 350×600”, product of Hosokawa Micron Corporation). The resultant coarsely pulverized product was finely pulverized using an airflow pulverizer (“JET MILL MODEL IDS-2”, product of Nippon Pneumatic Mfg. Co., Ltd.). The resultant finely pulverized product was classified using an elbow jet classifier (“ELBOW JET MODEL EJ-LABO”, product of Nittetsu Mining Co., Ltd.). Thus, toner mother particles with a volume median diameter (D50) of 8 μm were obtained. Note that the volume median diameter measurement was carried out using a particle size meter (“COULTER COUNTER MULTISIZER 3”, product of Beckman Coulter, Inc.).

### [Preparation of Fluororesin Particles]

Fluororesin particles (F-1) to (F-5) used as external additive particles were prepared by the following methods.

### (Fluororesin Particles (F-1))

An autoclave equipped with a stainless steel anchor type stirring impeller and a temperature adjusting jacket was used as a reaction vessel. The reaction vessel was charged with 3580 mL of deionized water, 3.58 g of ammonium perfluorooctanoate, and 94.1 g of paraffin wax (“PARAFFIN WAX-130, product of NIPPON SEIRO CO., LTD.). In the following, the components first charged into the reaction vessel may be referred to as “initial input materials”. After the inside of the reaction vessel was replaced with a nitrogen gas and tetrafluoroethylene (TFE), TFE was further pressurized into the reaction vessel. The reaction vessel was then heated so that the temperature of the contents of the reaction vessel reached 80° C. while the contents of the reaction vessel were stirred at a stirring speed of 250 rpm (also referred to below as a stirring speed X). Since then, the stirring of the contents of the reaction vessel at the stirring speed X was continued while the internal temperature of the reaction vessel was maintained at 80° C. until the polymerization reaction is terminated. An ammonium persulfate aqueous solution (concentration: 0.067% by mass) and a disuccinic acid peroxide aqueous solution (concentration: 1.61% by mass) were pressurized into the reaction vessel and supply of TFE was continued. In so doing, the amount of the TFE supplied was adjusted so that the internal pressure of the reaction vessel was kept constant (0.78 MPa). Thus, a polymerization reaction was allowed to proceed for 50 minutes (also referred to below as a polymerization time Y). In the polymerization reaction, the amount of the ammonium persulfate aqueous solution pressurized was set to 20 mL, the amount of the disuccinic acid peroxide aqueous solution pressurized was set to 20 mL, and the amount of the TFE pressurized was set to 1735 g. After 50 minutes from the initiation of the polymerization reaction, the supply of the TFE and the stirring of the contents of the reaction vessel were stopped to terminate the polymerization reaction.

To a reaction product in a latex state resulting from the polymerization reaction, 100 mL of an ammonium hydroperfluorononanoate aqueous solution (concentration: 10% by mass) was added. Next, hot water was added to the reaction product to adjust the temperature of the reaction product to 50° C. Next, 10 mL of nitric acid (concentration: 60% by mass) was added to the reaction product, and at the same time the reaction product was stirred at a stirring speed of 250 rpm. As a result, fluororesin particles (F-1) started coagulating from the reaction product. Next, the stirring of the reaction product was continued for 1 hour to sufficiently separate the fluororesin particles (F-1) from the solvent. Next, the solvent was removed from the fluororesin particles (F-1) and the fluororesin particles (F-1) were dried to obtain fluororesin particles (F-1) being polytetrafluoroethylene particles with a number average primary particle diameter of 200 nm.

### (Fluororesin Particles (F-2))

Fluororesin particles (F-2) were prepared according to the same method as that for preparing the fluororesin particles (F-1) in all aspects other than change of the polymerization time Y to 40 minutes. The fluororesin particles (F-2) were polytetrafluoroethylene particles with a number average primary particle diameter of 100 nm.

### (Fluororesin Particles (F-3))

Fluororesin particles (F-3) were prepared according to the same method as that for preparing the fluororesin particles (F-1) in all aspects other than change of the stirring speed X to 200 rpm and change of the polymerization time Y to 60 minutes. The fluororesin particles (F-3) were polytetrafluoroethylene particles with a number average primary particle diameter of 300 nm.

### (Fluororesin Particles (F-4))

Fluororesin particles (F-4) were prepared according to the same method as that for preparing the fluororesin particles (F-1) in all aspects other than the following changes. In the preparation of the fluororesin particles (F-4), the reaction vessel was charged with 3580 mL of deionized water, 3.58 g of ammonium perfluorooctanoate, 94.1 g of paraffin wax (“PARAFFIN WAX-130”, product of NIPPON SEIRO CO., LTD.), and 2.9 g of perfluoro(propyl vinyl ether) as the initial input materials charged first. The fluororesin particles (F-4) were tetrafluoroethylene-perfluoroalkylvinylether copolymer (PFA) particles with a number average primary particle diameter of 200 nm.

### (Fluororesin Particles (F-5))

Into a stirring type glass-lined autoclave equipped with a jacket capable of accommodating 7500 parts by mass of water, 2000 parts by mass of pure water subjected to deminaralization and degassing and 1.0 parts by mass of ω-hydroperfluoroheptanoic acid (fluoroalkyl carboxylic acid) were charged. After the air in the autoclave has been fully replaced with pure nitrogen, the pure nitrogen was eliminated. Next, 2000 parts by mass of hexafluoropropene (HFP) ware pressurized into the autoclave. Next, TFE was pressurized into the autoclave until the internal pressure of the autoclave reached 8.3 kg/cm². Next, the internal temperature of the autoclave was adjusted to 25.5° C. and stirring was started. Next, di(ω-hydrododecafluoroheptanoyl)peroxide as a polymerization initiator and methanol as a molecular weight regulator were added into the autoclave. A reaction started immediately. During the reaction, TFE was successively added into the autoclave according to drops of the internal pressure of the autoclave to keep the internal pressure of the system constant. After the reaction for 1-hour, excess monomers were purged from the autoclave. The polymer was separated from the autoclave and washed and dried. Thus, fluororesin particles (F-5) were obtained. The fluororesin particles (F-5) were tetrafluoroethylene-hexafluoropropylene copolymer (FEP) particles with a number average primary particle diameter of 200 nm.

### [Preparation of Specific External Additive Particles]

Strontium titanate particles (Sr-1), strontium titanate particles (Sr-2), barium titanate particles (Ba-1), and barium titanate particles (Ba-2) being specific external additive particles were prepared by the following method. Note that where the amount of a specific raw material is expressed as “X mol in terms of TiO₂” in the preparation of the specific external additive particles, it indicates that a product containing an X mol of TiO₂ can be obtained when the specific raw material is caused to react at a percentage yield of 100%.

### (Strontium Titanate Particles (Sr-1))

A solution with a pH of 9.0 was prepared (desulfurization) by adding a 4N sodium hydroxide aqueous solution to titanyl sulfate (product of YONEYAMA YAKUHIN KOGYO CO., LTD.). After 6N hydrochloric acid was added to the resultant solution to adjust the pH thereof to 5.8, the solution was filtered and water-washed. After the water washing, water was added to a wet cake of the filtrate to prepare a slurry. The amount of the water added was such that the concentration of the slurry reached 2.13 mol/L in terms of TiO₂. To the resultant slurry, 6N hydrochloric acid was added (deflocculation) to adjust the pH thereof to 1.4. Of the deflocculated slurry, 1.877 mol of slurry in terms of TiO₂ was added into a reaction vessel.

A strontium chloride aqueous solution (containing 2.159 mol of strontium chloride) was added into the reaction vessel (molar ratio (Sr/Ti) of Sr to Ti: 1.15). Next, a lanthanum chloride aqueous solution (containing 0.216 mol of lanthanum) was added into the reaction vessel (molar ratio (La/Sr) of La to Sr: 0.10). Next, water was added into the reaction vessel. The amount of the water added was such that the concentration of the slurry in the reaction vessel reached 0.939 mol/L in terms of TiO₂. Next, the reaction vessel was heated until the temperature of the contents of the reaction vessel reached 90° C. under stirring of the contents of the reaction vessel. Thereafter, while the contents of the reaction vessel were stirred and mixed with the temperature of the contents maintained at 90° C., 553 mL of a 10N sodium hydroxide aqueous solution was added into the reaction vessel over 100 minutes (addition time T1). Thereafter, the contents of the reaction vessel were caused to react by stirring at 95° C. for 1 hour. After the reaction, the contents of the reaction vessel were cooled to 50° C. Next, 1N hydrochloric acid was added to the contents of the reaction vessel while maintaining the temperature of the contents of the reaction vessel at 50° C. until the pH of the contents of the reaction vessel reached 5.0. Next, the contents of the reaction vessel was stirred at 50° C. for 1 hour to react. Thereafter, a supernatant was removed from the contents of the reaction vessel and a precipitate (product) was collected. Thereafter, pure water was added to the precipitate and a supernatant was removed by decantation (precipitate washing). After the washing, the product was filtered using a Buchner funnel and a resultant wet cake of the filtrate (product) was dried in an atmosphere at 120° C. for 10 hours. Thus, a base (strontium titanate particles) was obtained.

Toward 100 parts by mass of the base, 15 parts by mass of isobutylmethoxysilane was evenly sprayed using a spray. Thereafter, the base with isobutylmethoxysilane sprayed thereto was sufficiently mixed at 110° C. for 2 hours (hydrophobization). As a result, hydrophobized strontium titanate particles (Sr-1) were obtained (number average primary particle diameter 50 nm).

### (Strontium Titanate Particles (Sr-2))

Hydrophobized strontium titanate particles (Sr-2) (number average primary particle diameter 80 nm) were prepared according to the same method as that for preparing the strontium titanate particles (Sr-1) in all aspects other than that the addition time T1 for adding 553 mL of the 10N sodium hydroxide aqueous solution was changed to 180 minutes.

### (Barium Titanate Particles (Ba-1))

A 4N sodium hydroxide aqueous solution was added to titanyl sulfate (product of YONEYAMA YAKUHIN KOGYO CO., LTD.) to prepare a solution with a pH of 9.0 (desulfurization). After 6N hydrochloric acid was added to the solution to adjust the pH of the solution to 5.8, the solution was filtered and water-washed. After the washing, water was added to a wet cake of the filtrate to prepare a slurry. The amount of the water added was such that the concentration of the slurry reached 2.13 mol/L in terms of TiO₂. To the resultant slurry, 6N hydrochloric acid was added (deflocculation) to adjust the pH thereof to 1.4. Of the deflocculated slurry, 1.877 mol of the slurry in terms of TiO₂ was added into a reaction vessel.

Into the reaction vessel, 2.159 mol (molar ratio (Ba/Ti) of Ba to Ti: 1.15) of a barium chloride aqueous solution was added. Next, a lanthanum chloride aqueous solution (containing 0.216 mol of lanthanum) was added into the reaction vessel (molar ratio (La/Ba) of La to Ba: 0.10). Next, water was added into the reaction vessel. The amount of the water added was such that the concentration of the slurry in the reaction vessel reached 0.939 mol/L in terms of TiO₂. Next, the reaction vessel was heated until the temperature of the contents of the reaction vessel reached 90° C. under stirring of the contents of the reaction vessel. Thereafter, while the contents of the reaction vessel were stirred and mixed with the temperature of the contents maintained at 90° C., 553 mL of 10N sodium hydroxide aqueous solution was added into the reaction vessel over 30 minutes (addition time T2). Next, the contents of the reaction vessel were caused to react under stirring at 95° C. for 1 hour. After the reaction, the contents of the reaction vessel were cooled to 50° C. Next, 1N hydrochloric acid was added to the contents of the reaction vessel while maintaining the temperature of the contents of the reaction vessel at 50° C. until the pH of the contents of the reaction vessel reached 5.0. Next, the contents of the reaction vessel were stirred at 50° C. for 1 hour to react. Thereafter, a supernatant was removed from the contents of the reaction vessel and a precipitate (product) was collected. Thereafter, pure water was added to the precipitate and a supernatant was removed by decantation (precipitate washing). After the precipitate washing, the product was filtered using a Buchner funnel and a resultant wet cake of the filtrate (product) was dried in an atmosphere at 120° C. for 10 hours. Thus, a base (barium titanate particles) was obtained.

Toward 100 parts by mass of the base, 15 parts by mass of isobutylmethoxysilane was evenly sprayed using a spray. Thereafter, the base with isobutylmethoxysilane sprayed thereto was sufficiently mixed at 110° C. for 2 hours (hydrophobization). As a result, hydrophobized barium titanate particles (Ba-1) (number average primary particle diameter 20 nm) were obtained.

### (Barium Titanate Particles (Ba-2))

Barium titanate particles (Ba-2) (number average primary particle diameter 50 nm) were prepared according to the same method as that for preparing the barium titanate particles (Ba-1) in all aspects other than change of the addition time T2 for adding 553 mL of the 10N sodium hydroxide aqueous solution to 100 minutes.

### <Toner Production>

Toners of Examples 1 to 5 and Comparative Examples 1 to 4 were produced by the following methods.

### Example 1

Using an FM mixer (“FM-10B”, product of Nippon Coke & Engineering Co., Ltd.), 100 parts by mass of the aforementioned toner mother particles, 2.0 parts by mass of hydrophobized silica particles (“CAB-O-SIL (registered Japanese trademark) TG-7120”, product of Cabot Corporation, number average primary particle diameter 20 nm), 0.5 parts by mass of the fluororesin particles (F-1), and 1.0 parts by mass of the strontium titanate particles (St-1) were mixed at a rotational speed of 3500 rpm for 25 minutes (external additive addition time). The resultant mixture was sifted using a 200 mesh sieve (aperture 75 μm). Thus, a toner of Example 1 was obtained that included the toner mother particles and the external additive particles (the fluororesin particles (F-1), the strontium titanate particles (St-1), and the silica particles) attached to the surfaces of the toner mother particles.

### Examples 2 to 5 and Comparative Examples 1 to 4

Toners of Examples 2 to 5 and Comparative Examples 1 to 4 were produced according to the same method as that for preparing the toner of Example 1 in all aspects other than that the external additive addition time and the type and amount of the external additive particles added were changed to those shown below in Table 2. Note that “Part” below in Table 2 indicates the amount (part by mass) of corresponding particles relative to 100 parts by mass of the toner mother particles. Also, “Diameter” indicates a number average primary particle diameter of corresponding particles.

### [Detachment Fraction of Silica Particles]

The detachment fraction of the silica particles in each of the toners of Examples 1 to 5 and Comparative Examples 1 to 4 was measured by the following method. Results are shown below in Table 2. Into a 200-mL glass bottle, 100 mL of ion exchange water and 5.5 mL of a nonionic surfactant-containing aqueous solution (“Triton X-100”, product of Acros Organics, polyoxyethylene alkyl phenyl ether) at a concentration of 10% by mass were added. Next, 5 g of a measurement target (any of the toners of Examples 1 to 5 and Comparative Examples 1 to 4) was added into the glass bottle. Next, the contents of the glass bottle were stirred 30 times and then left to stand for 1 hour. Next, the contents of the glass bottle were stirred 20 times. Next, an ultrasonic transducer of an ultrasonic homogenizer (“HOMOGENIZER TYPE VCX750, CV33” product of Sonics & Materials, Inc.) was put into the glass bottle and ultrasonication was carried out under the following conditions (apparatus output 30%).

### (Conditions for Ultrasonication)

Treatment time: continuous 60 seconds
Frequency: 20 kHz
Output: 225 W
Distance between ultrasonic transducer and bottom of glass bottle: 10 mm

Next, a mass M₁ of the silica particles included in the measurement target before the ultrasonication and a mass M₃ of the silica particles included in the measurement target after the ultrasonication were measured by fluorescent X-ray analysis. The difference “mass M₃−mass M₁” was taken as a mass M₂ of the silica particles that had separated from the toner mother particles of the measurement target after the ultrasonication. A percentage (100×M₂/M₁) of the mass M₂ of the silica particles that had separated from the toner mother particles of the measurement target after the ultrasonication to the mass M₁ of the silica particles included in the measurement target before the ultrasonication was calculated. The calculated result was taken as detachment fraction of the silica particles.

### (Fluorescent X-ray Analysis)

Using a tablet forming compressor (“BRE-33”, product of MAEKAWA TESTING MACHINE MFG. Co., Ltd.), 0.5 g of the measurement target (any of the toners of Examples 1 to 5 and Comparative Examples 1 to 4) were press-formed to produce a columnar pellet with a diameter of 20 mm. Fluorescent X-ray analysis was carried out on the resultant pellet under the following conditions to plot an X-ray fluorescence spectrum (horizontal axis: energy, vertical axis: intensity (number of photons)) with a peak derived from silicon. The X-ray intensity of the peak derived from the measurement element on the plotted X-ray fluorescence spectrum was converted into a percentage content (unit: % by mass) thereof using a pre-plotted calibration curve. An amount of the silica particles in the measurement target was calculated based on the converted percentage content.

### (Conditions for Fluorescent X-ray Analysis)

Analysis apparatus: scanning fluorescent X-ray analyzer (“ZSX”, product of Rigaku Corporation)
X-ray tube (X-ray source): rhodium (Rh)
Excitation conditions: tube voltage of 50 kV and tube current of 50 mA
Measurement area (X-ray irradiation range): diameter of 30 mm
Measurement element: silicon

TABLE 2

| | | | | | Specific external additive | | | Silica particles | | |
|---|---|---|---|---|---|---|---|---|---|---|
| | Fluororesin particles | | | | particles | | | | Detachment | External additive |
| | | | Diameter | | | Diameter | | | fraction | addition time |
| | Type | Resin | [nm] | Part | Type | [nm] | Part | Part | [wt %] | [min] |
| Example 1 | F-1 | PTFE | 200 | 0.5 | Sr-1 | 50 | 1.0 | 2.0 | 10 | 25 |
| Example 2 | F-2 | PTFE | 100 | 0.7 | Ba-1 | 20 | 0.5 | 2.5 | 20 | 10 |
| Example 3 | F-3 | PTFE | 300 | 0.3 | Sr-2 | 80 | 2.0 | 1.5 | 5 | 35 |
| Example 4 | F-4 | PFA | 200 | 0.5 | Ba-1 | 20 | 0.5 | 2.0 | 10 | 25 |
| Example 5 | F-5 | FEP | 200 | 0.5 | Sr-2 | 80 | 2.0 | 2.0 | 10 | 25 |
| Comparative | F-1 | PTFE | 200 | 0.5 | — | — | — | 2.0 | 10 | 25 |
| Example 1 | | | | | | | | | | |
| Comparative | F-1 | PTFE | 200 | 0.5 | Sr-1 | 50 | 1.0 | 2.0 | 25 | 5 |
| Example 2 | | | | | | | | | | |
| Comparative | F-1 | PTFE | 200 | 0.5 | Ba-2 | 50 | 1.0 | 1.5 | 4 | 40 |
| Example 3 | | | | | | | | | | |
| Comparative | — | — | — | — | Sr-1 | 50 | 1.0 | 2.0 | 10 | 25 |
| Example 4 | | | | | | | | | | |

### <Evaluation>

With respect to each of the toners of Examples 1 to 5 and Comparative Examples 1 to 4, occurrence or non-occurrence of a white line and offset and image density of formed images were evaluated by the following methods. Evaluation results are shown below in Table 3.

### [Evaluation Apparatus]

An evaluation apparatus used was “PA-2000” produced by KYOCERA Document Solutions Japan Inc. being a monochrome printer using a non-magnetic one-component developer. The evaluation apparatus included a fixing roller and a development device including a restriction blade and a development roller. An evaluation target (any of the toners of Examples 1 to 5 and Comparative Examples 1 to 4) was loaded into the development device of the evaluation apparatus. The recording medium used was “MULTIPAPER SUPER WHITE A4” produced by ASKUL Corporation.

### [First Image Formation Test]

A first image formation test was carried out at a temperature of 23° C. and a relative humidity of 50%. Using the evaluation apparatus, a pattern image (printing rate 5%) was intermittently printed on 1500 sheets of the recording medium. In the intermittent printing, a series of consecutive two-sheet printing and an interval of 300 seconds was repeated.

### [Second Image Formation Test]

A second image formation test was carried out at a temperature of 10° C. and a relative humidity of 10%. Using the evaluation apparatus, a pattern image (printing rate 1%) was consecutively printed on 1000 sheets of the recording medium. After the consecutive printing, a solid image was formed on a sheet of the recording medium using the evaluation apparatus.

### [White Line]

Images printed at every 50^{th} print in the first image formation test were visually observed to check for the occurrence or non-occurrence of a white line. White line evaluation was carried out according to the following criteria. Note that the number of images at and after which a white line has occurred is indicated in parentheses for each evaluation target (Comparative Examples 2 to 4) where a white line had occurred.

### (Criteria of White Line)

Good (A): A white line was not recognized in all images.
Poor (B): A white line occurred in middle of image formation.

### [Offset]

After the second image formation test, the fixing roller of the evaluation apparatus was visually observed to check the presence or absence of contamination (offset) on the fixing roller. Offset was evaluated according to the following criteria.

### (Criteria of Offset)

Good (A): Offset was not recognized.
Poor (B): Offset had occurred.

### [Image Density]

The solid image formed after the second image formation test was taken as an evaluation image. The image density (ID) of the solid image included in the evaluation image was measured using a reflectance densitometer (“RD914”, product of X-Rite Inc.). Image density was evaluated according to the following criteria. Note that the measurement value for image density was indicated in parentheses for each evaluation target (Comparative Examples 3 and 4) rated as poor in image density below in Table 3.

### (Criteria of Image Density)

Good (A): ID of at least 1.20
Poor (A): ID of less than 1.20

TABLE 3

| | White line | Offset | Image density |
|---|---|---|---|
| Example 1 | A | A | A |
| Example 2 | A | A | A |
| Example 3 | A | A | A |
| Example 4 | A | A | A |
| Example 5 | A | A | A |
| Comparative Example 1 | A | B | A |
| Comparative Example 2 | B (1400^{th} image) | A | A |
| Comparative Example 3 | B (1450^{th} image) | A | B (ID: 1.15) |
| Comparative Example 4 | B (1000^{th} image) | A | B (ID: 1.10) |

As shown in Tables 2 and 3, the toners of Examples 1 to 5 each were a toner including toner particles. The toner particles each included a toner mother particle and external additive particles attached to the surface of the toner mother particle. The external additive particles included fluororesin particles, specific external additive particles, and silica particles. The specific external additive particles contained barium titanate or strontium titanate. The silica particles had a detachment fraction of at least 5% by mass and no greater than 22% by mass. The toners of Examples 1 to 5 each formed images with desired image density while inhibiting occurrence of a white line and offset.

By contrast, the toner of Comparative Examples 1 did not include any specific external additive particles. The toner of Comparative Example 1 did not release charge of the toner particles when the toner particles were overcharged due to the fluororesin particles coating the restriction blade or the development roller. As a result, it is determined that the toner of Comparative Example 1 caused offset due to development of excessive amount of the toner resulting from an increase in thickness of the toner layer during image formation.

The toner of Comparative Example 2 had a detachment fraction of the silica particles of greater than 22% by mass. It is determined that with the toner of Comparative Example 2, a large amount of the silica particles were separated from the toner mother particles during image formation and adhered to the restriction blade and the development roller. Once a large amount of silica particles adhere to the restriction blade and the developer bearing member, the silica particles function as an abrasive to polish (remove) the fluororesin particles coating the restriction blade and the developer bearing member. The toner particles are likely to adhere to the restriction blade and the developer bearing member from which the fluororesin particles have been removed by polishing. As a result, it is determined that the toner of Comparative Example 2 caused a white line.

The toner of Comparative Example 3 had a detachment fraction of the silica particles of less than 5% by mass. It is determined that the toner of Comparative Example 3 had low fluidity of the toner particles due to the silica particles strongly attaching to the toner mother particles. As a result, the toner of Comparative Example 3 was rated as poor in image density. In addition, a white line occurred with the toner of Comparative Example 3.

The toner of Comparative Examples 4 did not include fluororesin particles. The fluororesin particles in the toner of Comparative Example 4, which did not coat the restriction blade and the development roller, readily adhered to the restriction blade and the development roller. As a result, a white line occurred with the toner of Comparative Example 4. In addition, the toner of Comparative Example 4 was also rated as poor in image density.

What is claimed is:

1. A toner comprising
toner particles, wherein
the toner particles each include a toner mother particle and external additive particles attached to a surface of the toner mother particle,
the external additive particles include fluororesin particles, specific external additive particles, and silica particles,
the specific external additive particles contain barium titanate or strontium titanate,
the silica particles have a detachment fraction of at least 5% by mass and no greater than 22% by mass, and
the detachment fraction of the silica particles is a percentage (100×M₂/M₁) of a mass M₂ of silica particles of the silica particles that have separated from the toner mother particles after ultrasonication to a mass M₁ of the silica particles included in the toner particles before the ultrasonication, the ultrasonication being application of ultrasonic vibration with a frequency of 20 kHz and an output of 225 W for 60 seconds to a mixed liquid of 5 g of the toner and 105.5 g of a nonionic surfactant-containing aqueous solution containing 0.55 g of a nonionic surfactant.

2. The toner according to claim 1, wherein
the specific external additive particles have a content of at least 0.3 parts by mass and no greater than 5.0 parts by mass relative to 100 parts by mass of the toner mother particles.

3. The toner according to claim 1, wherein
the specific external additive particles have a number average primary particle diameter of at least 15 nm and no greater than 100 nm.

4. The toner according to claim 1, wherein
the fluororesin particles have a content of at least 0.1 parts by mass and no greater than 2.0 parts by mass relative to 100 parts by mass of the toner mother particles.

5. The toner according to claim 1, wherein
the fluororesin particles have a number average primary particle diameter of at least 70 nm and no greater than 400 nm.

6. The toner according to claim 1, wherein
the toner is used as a non-magnetic one-component developer.

7. An image forming apparatus comprising:
a non-magnetic one-component developer;
an image bearing member; and
a development device that develops an electrostatic latent image formed on a surface of the image bearing member by supplying the non-magnetic one-component developer to the electrostatic latent image, wherein
the non-magnetic one-component developer is the toner according to claim 6,
the development device includes a developer bearing member that carries the non-magnetic one-component developer and a restriction blade that restricts a thickness of a developer layer constituted by the non-magnetic one-component developer, and
the development device supplies the non-magnetic one-component developer to the electrostatic latent image while forming the developer layer using the restriction blade in contact with the developer bearing member.
